(19) United States
(12) Patent Application Publication
(10) Pub. No.: US 2023/0206786 A1
(43) Pub. Date: Jun. 29, 2023

(54) SEALING LABEL, METHOD FOR PRODUCING A SEALING LABEL AND USE

(71) Applicant: SCRIBOS GmbH, Heidelberg (DE)

(72) Inventors: Tobias Kresse, Berlin (DE); Patrick Maskow, Edingen-Neckarhausen (DE); Bernd Terhalle, Mannheim (DE); Eduard Ziegler, Mannheim (DE)

(21) Appl. No.: 18/077,363

(22) Filed: Dec. 8, 2022

(30) Foreign Application Priority Data
Dec. 23, 2021 (DE) 10 2021 134 470.0
Dec. 23, 2021 (DE) 20 2021 107 042.0

(51) Int. Cl. G09F 3/03; G09F 3/10

(52) U.S. Cl. CPC G09F 3/0341; G09F 3/10; G09F 3/0388; G09F 2003/0225

(57) ABSTRACT

A sealing label (1) with a carrier ply (2), an adhesive layer (4), and an intermediate ply (3) arranged between the carrier ply (2) and the adhesive layer (4) with predetermined breaking points (30) for the internal separation of the intermediate ply (3), wherein the carrier ply (2) has at least a paper layer (21). A use of the sealing label (1), the production method thereof and a use of a carrier ply (2) including or consisting of a paper layer (21) for producing the sealing label (1).

### BACKGROUND OF THE INVENTION

The invention relates to a sealing label, the use thereof and a method for producing a sealing label.

It is known to provide articles, such as packaging, containers, envelopes and casing parts, in a closed state with a seal for proof of opening. For this purpose, for example sealing labels are affixed to the article to be sealed by means of an adhesive layer, with the result that it is necessary to detach or rip the sealing label to open the article. Unstable layers can be provided inside the sealing label against a destruction-free detachment and re-attachment thereof. For such sealing labels, the carrier films are formed of self-supporting plastic films, such as stretched thermoplastic films. These carrier films can easily be designed transparent, with the result that the internal destruction accompanying the detachment is visible when the label is stuck back on or put back together. Here, the force exerted when detaching the label from the sealed article is introduced into the label via the carrier film. Due to their high stability, uniform internal structure and low manufacturing tolerances, the plastic films guarantee that a reliable and targeted transmission of force to the internal layers via the plastic film takes place when the sealing label is detached, and the destruction of the label is initiated during the detachment.

Because of the low surface energy of the plastic films and the poor wettability associated with it, the plastic films of the labels are subjected to printing pretreatments and special printing primers for increasing the wettability are deposited, in order to achieve a sufficient surface tension and thus to enable printing with sufficient ink adhesion. Since the effect of printing pretreatments, such as corona or plasma treatments, is time-limited and the use of printing primers is restricted to a specific application area, on the one hand a subsequent printing of these prefabricated labels by the user, thus for example in the packaging process, proves to be difficult and on the other hand a large amount of resources are required, such as in particular fossil-based raw materials for the plastic films and the energy required for the surface treatments.

### SUMMARY OF THE INVENTION

An object of the present invention is thus to specify an improved sealing label and improved methods for producing a sealing label and an improved use of a sealing label.

The object is achieved in particular by means of a sealing label according to the present invention as well as by means of a method according to the present invention.

The object is achieved by a sealing label which has a carrier ply, an adhesive layer, and an intermediate ply arranged between the carrier ply and the adhesive layer. The intermediate ply has predetermined breaking points for the internal separation of the intermediate ply, wherein the carrier ply has at least a paper layer.

The object is further achieved by a method for producing a sealing label. The sealing label according to the invention has been or is produced in particular by the method according to the invention. The method comprises the following steps, in particular in the specified order:
a) providing a carrier ply, wherein the carrier ply has at least a paper layer,
b) applying an intermediate ply to the carrier ply, wherein the intermediate ply has predetermined breaking points for the internal separation of the intermediate ply, or the predetermined breaking points are produced in the intermediate ply,
c) applying an adhesive layer to the intermediate ply.

The object is also achieved by using the sealing label in particular for sealing a product. In addition, the object is in particular achieved by using a carrier ply comprising a paper layer or consisting of a paper layer for producing the sealing label.

It has surprisingly been shown that it is possible to reliably achieve a separation of the intermediate ply within itself via a force introduced by the carrier ply with the paper layer, although the internal separation, in particular along a direction between the carrier ply and the adhesive layer, can cause a high shearing force in the carrier ply and paper, due to its inhomogeneity and relatively low stability, tends to come apart within itself, with the result that a targeted transmission of force to activate internal predetermined breaking points appears to be made more difficult. Thus, it is possible for example to provide striking and noticeable proofs of first opening through fine structures of the intermediate ply in the form of motifs or lettering, which are detached with the carrier ply. At the same time, an improved subsequent decorability is achieved because the absorbency of the surface of the sealing label can be greatly increased compared with conventional sealing labels with plastic films, such as thermoplastic films, due to the paper layer of the carrier ply. A very wide range of extremely varied printing inks can, for example, be printed on the paper surface without special pretreatment. A decoration, in particular printing, can thus be carried out at a very late manufacturing stage, since an outer surface that is easy to decorate is available for this. In particular, an improved subsequent printability, for example with batch-specific or item-unique information, such as logistical information, expiry dates, weblinks in the form of QR codes etc., is thus achieved, which is increasingly gaining in importance for example in the packaging industry. It has additionally surprisingly been shown that it is possible to design the intermediate ply such that a carrier ply detached together with parts of the intermediate ply can be fed into a paper recycling process, for example also in the case where the entire sealing label would not be suitable for the paper recycling process. An increased recyclability is thus achieved. Thus, in particular the design possibilities of the sealing label are improved by the present invention, with at the same time increased cost and resource efficiency.

By a label is meant in particular a self-adhesive multilayer body. By sealing is meant in particular provision with a proof of first opening. The sealing label is in particular a self-adhesive multilayer body for providing a proof of first opening on a product to be sealed.

By a ply or a layer is preferably meant a substantially two-dimensional structure. A ply or layer can in particular itself be monolayered or multilayered.

A paper layer is in particular a layer which comprises or consists of paper. By paper is preferably meant a two-dimensional material with a mass per unit area of from 7 g/m² to 225 g/m², which is made from pulps and in particular has been or is obtained by removing water from a fibrous suspension. In particular, paper contains constituents selected individually or in combination from: plant fibers, plastic fibers, cotton, wool, silk, cellulose, pulp, wood pulp, recycled fiber.

By predetermined breaking points is meant, in particular, one or more areas at which a separation takes place when a predetermined value of a mechanical load is exceeded. Through the predetermined breaking points, a proof of first opening is preferably provided by means of an in particular provable separation of the intermediate ply within itself. They are preferably predetermined breaking points for the internal separation of the intermediate ply through a force passed into the sealing label via the carrier ply. This force is preferably the force exerted during detachment of the carrier ply of the sealing label glued to a product to be sealed.

In particular, the predetermined breaking points in the intermediate ply provide an opening feature, which can become visible through the internal separation of the intermediate ply, preferably with a contour along the predetermined breaking points. The contour is visible and preferably in the shape of a motif, preferably when viewed perpendicular to a plane spanned by the sealing label. The opening feature comprises, for example, at least one machine-readable feature, in particular a data matrix code or QR code.

In particular, the predetermined breaking points are arranged in an opening area of the sealing label, which preferably contains the opening feature when viewed perpendicular to a plane spanned by the sealing label. It is also possible for the sealing label to extend beyond the opening area.

The predetermined breaking points preferably run at least along a direction between the carrier ply and the adhesive layer. By a direction between the carrier ply and the adhesive layer can in particular be meant a direction pointing from the adhesive layer to the carrier ply, in particular parallel to the surface normals of a plane spanned by the sealing label, preferably the carrier ply and/or the adhesive layer, as well as also a direction pointing from the carrier ply to the adhesive layer. The predetermined breaking points along a direction between the carrier ply and the adhesive layer in particular cause a comparatively high shearing in the carrier ply. It is furthermore possible for the intermediate ply to have predetermined breaking points for the internal separation perpendicular or transverse to a direction between the carrier ply and the adhesive layer, in particular perpendicular to the surface normals of a plane spanned by the sealing label, preferably the carrier ply and/or the adhesive layer.

A plane spanned by the sealing label, by a ply or layer of the sealing label, is preferably spanned by two directions, in which the sealing label or the corresponding ply or layer has the much larger dimensions, for example by the x and y direction in a Cartesian co-ordinate system, when the z direction in particular points in the direction of the thickness of the sealing label or the corresponding ply or layer and thus in particular parallel to the surface normals of a plane spanned by the sealing label, the corresponding ply or layer. A viewing perpendicular to a plane spanned by the sealing label or a ply or layer thereof can thus in particular also be understood as a viewing in the direction of the broadening of the thickness, as a top view, view from below and/or view in the direction of the surface normals.

Advantageous designs of the invention are described in the dependent claims.

It is possible for the paper layer to be arranged directly on the intermediate ply.

It is also possible for the carrier ply to have a varnish layer, which is preferably arranged on the side of the paper layer facing the intermediate ply. The varnish layer is preferably a leveling layer, which for example preferably reduces the absorbency and/or unevenness and/or roughness of the paper layer on one side and/or sets them to a substantially constant value in terms of area, in particular when viewed perpendicular to a plane spanned by the sealing label. The varnish layer is advantageously also a stabilization layer, which for example increases the tear resistance of the carrier ply. The following step is expediently carried out between step a) and step b):
a1) applying a varnish layer to the paper layer.

It is also conceivable that step a1) is carried out before step a) and the carrier ply is provided together with the paper layer and varnish layer in step a).

The intermediate ply is preferably applied to the varnish layer in step b).

The carrier ply preferably consists exclusively of the varnish layer and the paper layer. In particular, the varnish layer is or has been applied by means of flexographic printing.

An advantage of the varnish layer is that the optical properties of the carrier ply can be influenced in a targeted manner and thus, for example, an improved visibility of a first opening can be achieved. It is possible, for example, to adapt the image sharpness and cloudiness, in particular the haze value, of a carrier ply with paper layer and varnish layer compared with a carrier ply consisting of paper, in particular thus without the varnish layer, depending on requirements. The varnish layer preferably increases the image sharpness of the carrier ply and reduces the cloudiness of the carrier ply. In addition, a further advantage can be achieved that, through the varnish layer, a constant separation behavior, in particular of the intermediate ply, can be achieved, for example also across different paper batches. In particular, the varnish layer thus makes an improved introduction of force via the paper layer to the predetermined breaking points possible. The varnish layer can, for example, even out an absorbency unevenly distributed over the surface of the paper layer and level out unevennesses and, because of the high absorbency of the paper layer, the varnish layer can be particularly well anchored to the paper layer. Because the varnish layer preferably provides a more uniform surface and thus more uniform adhesion properties of the carrier ply, a particularly reliable and simple adaptation of the varnish layer and the intermediate ply to one another can be achieved for producing the predetermined breaking points.

The varnish layer, in particular when viewed perpendicular to a plane spanned by the sealing label, preferably in the z direction, is expediently arranged on at least one side or on both sides of a predetermined breaking point arranged in the intermediate ply and running in a direction between adhesive layer and carrier ply, in particular in the z direction. The varnish layer preferably has been or is applied to the paper layer over the whole surface. It is also possible for the intermediate ply to be completely overlapped by the varnish layer in particular when viewed perpendicular to a plane spanned by the sealing label. It is further possible for the varnish layer to extend beyond the intermediate ply and/or beyond the opening area or to be provided only in the opening area.

The layer thickness of the varnish layer preferably lies in a range of from 1 μm to 10 μm, particularly preferably in a range of from 1 μm to 5 μm.

For the measurement of the thickness of a layer or ply, preferably only the corresponding layer or ply, in particular the varnish layer, as such is used, preferably measured on a non-absorbent substrate. The measurement is carried out in particular on the cross section. It is also conceivable that a corresponding ply or layer has been or is applied in the sealing label with a corresponding layer thickness.

The varnish layer expediently has been or is applied to the paper layer with an application weight in a range of from 2 g/m² to 20 g/m², in particular from 2 g/m² to 10 g/m². Through a minimum value of 1 μm, it can advantageously be achieved that constant adhesive conditions have been or are provided for the intermediate ply even in the case of locally different absorbency of the paper layer. Through the maximum value of the layer thickness, it can advantageously be achieved that the detached carrier ply is recyclable and can be fed into a paper recycling process for example, because a majority of the part of the sealing label detached with the carrier ply preferably consists of the paper layer. The varnish layer advantageously has a layer thickness in a range of from 3 μm to 7 μm. Particularly constant adhesive conditions of a transparent paper, particularly preferably a paper with a mass of approx. 50 g/m², can hereby advantageously be guaranteed.

In particular, the varnish layer is semitransparent or transparent, preferably for wavelengths in a range of from 380 nm to 780 nm, preferably for wavelengths in the wavelength range visible to the human eye. It is also possible for the varnish layer to have a transmittance of over 90%, in particular wavelengths in a range of from 380 nm to 780 nm, preferably for wavelengths in the wavelength range visible to the human eye.

It is further possible for the varnish layer to be colorless, preferably at least in the wavelength range visible to the human eye and/or for wavelengths in a range of from 380 nm to 780 nm. In other words, the varnish layer preferably contains no colorants, in particular no dyes and/or pigments.

The varnish layer is preferably formed of a UV-curing varnish. A UV-curing varnish preferably is or has been cured by means of UV irradiation.

The UV-curing varnish preferably comprises the following three groups of UV-reactive materials: monomers or crosslinkers, binders or oligomers, as well as photoinitiators.

Monomers or crosslinkers have been or are used in particular for dissolving the binders, for setting the viscosity and the crosslinking of the UV system. Binders or oligomers are preferably mainly responsible for the properties in the cured state of the UV-curing varnish, such as for example scratch resistance, flexibility, elasticity and adhesion to substrates. Photoinitiators in particular decompose photochemically or by means of electron beam radiation into radicals and thereby preferably induce crosslinking reactions in the UV-curing varnish.

The UV-curing varnish preferably comprises binders, in particular also referred to as resins or oligomers, which comprise crosslinkable groups selected from: olefinic groups, vinyl ether groups or epoxide groups, acrylate oligomers and acrylate monomers, methacrylates, acrylated polyesters, polyethers or polyurethanes.

The UV-curing varnish preferably comprises monomers or crosslinkers selected individually or in combination from: butyl acrylate, (2-ethylhexyl) acrylate, as well as in particular multifunctional acrylates, such as preferably 1,4-butanediol di(meth)acrylate, 1,6-hexanediol di(meth)acrylate or trimethylolpropane tri(meth)acrylate.

The UV-curing varnish preferably comprises photoinitiators or photoinitiator systems, in particular radical photoinitiators, and in particular comprises the following substances selected individually or in combination from: ketone derivatives, diisopropyl xanthogen disulfide compounds, acetophenone compounds, benzophenones or benzoins.

The varnish layer, in particular the varnish layer as UV-curing varnish, preferably has been or is applied to the paper layer with an application weight in a range of from 2 g/m² to 20 g/m², in particular from 2 g/m² to 10 g/m². The varnish layer, in particular the UV varnish, preferably has been or is applied with a viscosity in a range of from 200 mPa*s to 500 mPa*s. It is hereby guaranteed, for example, that the varnish layer does not influence the printability of the paper layer and it levels out irregularities in the paper layer because on the one hand it is not absorbed too much and on the other it runs sufficiently to form an even surface.

The use of a carrier ply comprising or consisting of the paper layer with the varnish layer is also conceivable for producing the sealing label, wherein an intermediate ply with predetermined breaking points for the internal separation of the intermediate ply has been or is applied to the varnish layer and a decorative ply, in particular printed layer, is optionally applied to the side of the paper layer opposite the intermediate ply.

The paper layer in particular has a layer thickness in a range of from 0.05 mm to 0.1 mm. The paper layer is preferably self-supporting. It is further possible for a plane spanned by the sealing label, in particular in top view or perpendicular to the plane, to be formed entirely by the paper layer. It is thus possible for the supporting function of the carrier ply to be already guaranteed by the paper layer. It is further possible for the paper layer to form a first outer surface of the sealing label, in particular wherein this outer surface can be printed on or is printed on at least in areas. It is thus achieved in particular that an environmentally friendly carrier ply with at the same time a good printability can be used and it is possible to save on aftertreatments or further adhesion promoters or primers. Further, it is in particular possible, in the method for producing a sealing label, preferably to prepare several sealing labels on a self-supporting paper layer, for example as separate sheets or as a continuous web, which labels can then preferably be separated by mechanical separation, for example punching, cutting or by means of lasers.

The paper layer is preferably semitransparent or transparent, in particular for wavelengths in a range of from 380 nm to 780 nm, preferably for wavelengths in the wavelength range visible to the human eye. Advantageously, the carrier ply having the paper layer and optionally the varnish layer is at least semitransparent or transparent, in particular for wavelengths in a range of from 380 nm to 780 nm, preferably for wavelengths in the wavelength range visible to the human eye.

A transparency of the paper layer and of the carrier ply is advantageous in order to guarantee a clear proof of first opening even when the sealing label has been resealed.

The paper layer expediently contains or consists of a transparent paper. By transparent paper is preferably meant paper which appears transparent due to a high transmittance, preferably due to a transmittance of over 50%, further preferably of over 70%, in particular in the wavelength range between 380 nm and 780 nm. Transparent papers comprise, for example, silk papers, impregnated papers, plant-based papers and/or glassine.

For example, a transparent paper, in particular from Canson (Annonay Cedex, France), with a mass per unit area in the range of from 40 g/m² to 45 g/m² has a transmittance between 83% and 85%, a haze value of 100% and an image sharpness value of from 1.70% to 1.85%. A transparent paper, in particular from Canson, for example with a mass per unit area of 70 g/m², in turn has a transmittance of from 80% to 82%, a haze value of 100% and an image sharpness value of from 1.45% to 1.5%. A printer paper used for comparison, in particular from Steinbeis, with a whiteness degree of 90 according to ISO 11475:2017 (“Paper and board—determination of CIE whiteness D65/10 degrees (outdoor daylight)”, publication date: 2017-05) and a mass per unit area of 70 g/m², has for example a transmittance of 15.5%, a haze value of 103% and an image sharpness value of 0.67%.

By transmittance is preferably meant the ratio of the amount of light irradiated and/or incident on a medium to the amount of light which emerges on the opposite side of the medium, wherein in particular no change in the frequency or the wavelength of the light has taken place. The non-transmitted light is preferably reflected, scattered and/or absorbed by the medium. Thus, in the case of a transmittance of a medium of 0.9 or of 90% for example, 90% of the irradiated light can be perceived on the opposite side of the medium. By semitransparent is meant in particular a transmittance in a range of from 30% to 90%. By transparent is meant in particular a transmittance in a range of from 90% to 100%.

By haze or cloudiness is preferably meant here a diffuse scattering, in particular wide angle scattering, which in particular leads to a reduction in the imaging quality. Particles or inhomogeneities in the material, at which the light is in particular scattered in all spatial directions, preferably act as scattering centers, wherein advantageously only a small scattering intensity is allotted to each spatial angle. A reduction in the contrast and/or a milky-cloudy appearance is hereby brought about in particular, wherein this effect is preferably referred to as haze or cloudiness. Thus, the haze value preferably represents a measure of the cloudiness of transparent samples, for example of layers, plies and/or films.

By clarity or image sharpness is preferably meant here a diffuse scattering, in particular small angle scattering, which in particular leads to a reduction in the imaging quality. Here, the light is deflected within a small spatial angle, preferably less than 2.5°, such that the scattered light amount is concentrated in a narrow lobe. Hereby, in particular contours become distorted and/or appear less sharp, wherein this effect is preferably referred to as clarity or image sharpness. Thus, the clarity value preferably represents a measure of the image sharpness of transparent samples, for example of layers, plies and/or films.

For example, the haze value and the image sharpness value or clarity value are measured using the “BYK haze-gard i” measuring device from Byk-Gardner GmbH, Geretsried, Germany. The layer, ply or film to be measured is hereby preferably held in the open sample space of the measuring device and, in particular for the haze value, placed at the so-called “haze-port” of the device, wherein the measurement is advantageously carried out using illuminant D65, preferably with compensation. Then, the result of the measurement is preferably displayed on the screen of the measuring device. As the haze value and the clarity value are advantageously specified as a percentage (%), the value ranges of the haze value and the clarity value are therefore preferably 0% to 100%. The maximum value is preferably 100%. Values higher than 100% that possibly occur can be caused, for example, by additional scattered light effects and/or reflection effects during the measurement, in particular depending on the measurement principle used.

It is also possible for the paper layer to have a decorative ply, which in particular forms a second outer surface of the sealing label, or for the decorative ply to be applied to the paper layer. The decorative ply can advantageously have been or be applied directly to the paper layer.

The decorative ply is or has been deposited on the paper layer in particular partially, thus preferably not over the whole surface. It is thus possible for the paper layer to form a first outer surface of the sealing label and the decorative ply to form a second outer surface of the sealing label, preferably when viewed perpendicular to a plane spanned by the sealing label, preferably in top view. The decorative ply has been or is applied in particular in the shape of a motif. By “in the shape of a motif” is meant, for example, one or more shapes out of geometric shape, guilloche, endless pattern, image, symbol, logo, coat of arms, portrait, alphanumeric characters, QR code, barcode. Herewith, for example logistical information, expiry dates or weblinks can also have been or be applied in the form of QR codes.

It is possible for the decorative ply to comprise or consist of a printed layer. The decorative ply is preferably applied by means of a method selected individually or in combination from flexographic printing, offset printing, gravure printing, pad printing, inkjet printing, xerography, cold stamping, hot stamping, thermal transfer.

In particular it is possible for the following step to be carried out before and/or after an application of the sealing label to the product to be sealed:

applying a decorative ply, which in particular forms a second outer surface of the sealing label, to the paper layer, in particular printing it on. As already described above in particular, the application is preferably carried out partially, preferably in the shape of a motif.

Advantageously, the decorative ply can be applied at a very late manufacturing stage, with the result that an improved individualizability of the sealing labels is achieved. In addition, the decorative ply can form a very strong bond with the paper layer due to the absorbency of the paper layer, with the result that, through the decorative ply, at the same time the stability can be improved and, for example, a wide range of printing inks and printing methods can be used. In particular, flexographic inks usually adhere better to paper than to plastic, in particular to film. The Gemini™ series (UV flexographic inks) from the Flint Group, Luxembourg can be named here by way of example for flexographic inks.

It is also conceivable that the decorative ply comprises or consists of a metal layer. In addition, it is possible for the decorative ply to comprise or consist of an optically variable element. For this purpose, it is possible, for example, for the decorative ply to have a replication layer with a refractive and/or diffractive surface relief. The replication layer can consist of a thermoplastic, i.e. thermally curable or dryable, replication varnish or a UV-curable replication varnish or a mixture of such varnishes. It is advantageous if the surface relief introduced into the replication layer forms an optically variable element, in particular a hologram, Kinegram® or Trustseal®, a preferably sinusoidal diffraction grating, an asymmetric relief structure, a blazed grating, a preferably isotropic or anisotropic matte structure, or a light-diffracting and/or light-refracting and/or light-focusing micro- or nanostructure, a binary or continuous Fresnel lens, a microprism structure, a microlens structure or a combination structure thereof.

Using such structures or combinations thereof, diverse optical effects, which are also difficult to imitate and cannot be copied or can be copied only with difficulty with usual optical copying methods, can advantageously be achieved, with the result that a particularly forgery-proof sealing label can be provided.

The replication layer can also have been or be provided as outermost layer of the decorative ply and in particular have a surface relief, which preferably also has yet other functional properties as an alternative or in addition to the optical properties, for example selected individually or in combination from: tactile function, dirt-repellent function, moisture-repellent function, antimicrobial function.

The decorative ply preferably has been or is applied in register, in particular in register with the intermediate ply, preferably with the first functional layer and/or with the second functional layer.

In a preferred embodiment of the sealing label and of the method for producing a sealing label, the intermediate ply has one or more of the following layers or is formed of one or more of the following layers:
a first functional layer for setting an adhesive force in the intermediate ply, wherein the first functional layer preferably has been or is applied to the carrier ply not over the whole surface,
a first color layer, which preferably has been or is applied to the carrier ply and the first functional layer,
a second functional layer for setting an adhesive force in the intermediate ply, wherein the second functional layer preferably has been or is applied to the first color layer not over the whole surface,
a second color layer, which preferably has been or is applied to the second functional layer and first color layer over the whole surface.

Step b) expediently comprises one or more of the following steps, in particular in the specified order:
b1) applying a first functional layer for setting an adhesive force in the intermediate ply to the carrier ply, preferably not over the whole surface,
b2) applying a first color layer, in particular to the carrier ply and first functional layer,
b3) applying a second functional layer for setting an adhesive force in the intermediate ply, preferably not over the whole surface,
b4) applying a second color layer, in particular to the second functional layer and first color layer, preferably over the whole surface.

In particular, the separating effect of the predetermined breaking points for the internal separation of the intermediate ply preferably has been or is formed independently of the adhesion of the first and second color layers to one another by a structured deposition of the first and second functional layers, with the result that many different colors can advantageously be used. The first and second color layers preferably have been or are formed in different colors and preferably chosen to be as high-contrast as possible. In the present context, by color is meant in particular the entire color spectrum of the Panton® or RAL® colors as well as black and white.

The first color layer preferably has been or is applied to the carrier ply over the whole surface or at least arranged in the intermediate ply over the whole surface, preferably if the intermediate ply has been or is applied to the carrier ply not over the whole surface.

The first functional layer in particular has been or is applied directly to the varnish layer, i.e. preferably without further layers between the first functional layer and the varnish layer.

The adhesive layer preferably has been or is arranged on the intermediate ply over the whole surface, in particular when viewed perpendicular to a plane spanned by the sealing label. The adhesive layer preferably has been or is applied to the second color layer over the whole surface, in particular when viewed perpendicular to a plane spanned by the sealing label.

The predetermined breaking points in particular have been or are predefined in the intermediate ply by means of the adhesive forces set by the first and second functional layers. At least one layer or both layers out of the first functional layer and second functional layer are preferably formed as release varnish layer. It is also conceivable that at least one layer or both layers out of the first functional layer and second functional layer are formed as primer. A primer preferably increases the adhesion of layers which are adjoining or joined via the primer. A release varnish preferably reduces the adhesion of layers which are adjoining or joined via the release varnish.

In a preferred embodiment, the first functional layer reduces the adhesive force between the first color layer and the carrier ply, in particular compared with surrounding areas when viewed perpendicular to a plane spanned by the sealing label. The second functional layer preferably reduces the adhesive force between the first color layer and the second color layer, in particular compared with surrounding areas when viewed perpendicular to a plane spanned by the sealing label.

In particular, the first functional layer has been or is designed such that the adhesive force between the first functional layer and the first color layer is smaller than the adhesive force between the first color layer and a layer directly adjacent to it, in particular the carrier ply, preferably the paper layer or the varnish layer. It is alternatively or additionally also possible for the second functional layer to be designed such that the adhesive force between the second functional layer and the first color layer is smaller than the adhesive force between the second functional layer and a layer directly adjacent to it, in particular the second color layer and/or the adhesive layer.

Thus, it is possible, during the detachment of the carrier ply, in particular from a product sealed with the sealing label, for the first color layer to be detached from the carrier ply in an area determined by the first functional layer and to remain on the adhesive layer, in particular to remain on the second color layer. It is further possible, during the detachment of the carrier ply, for the first color layer to be detached from the adhesive layer in an area determined by the second functional layer and thus to be detached with the carrier ply. The first color layer thus separates within itself and is detached together with the carrier ply outside of the areas determined by the first functional layer. In this embodiment, the intermediate ply thus separates in particular along the predetermined breaking points through the separation of the first color layer within itself and the separation of the first color layer from the first functional layer and the second functional layer.

Expediently, the first and second functional layers have been or are arranged not overlapping at least in areas, in particular when viewed perpendicular to a plane spanned by the sealing label. The first and second functional layers preferably have been or are formed complementary to one another. Complementary means that, in particular when viewed perpendicular to a plane spanned by the sealing label, the two functional layers cover the entire plane in the opening area of the sealing label and the functional layers in particular do not overlap. The second functional layer preferably has been or is partially applied as a negative of the first functional layer, preferably applied to the first color layer.

The intermediate ply preferably has an internal adhesive force which is smaller than the internal adhesive force of the carrier ply and the internal adhesive force of the adhesive layer.

The ratio of the internal adhesive force of the carrier ply to the internal adhesive force of the intermediate ply is preferably greater than 1, in particular greater than 5, particularly preferably greater than 7. It is thus achieved in particular that the paper does not come apart within itself before the separation at the predetermined breaking points takes place.

The adhesive force between the first color layer and the varnish layer is preferably greater than the adhesive force between the first color layer and the first functional layer. The adhesive force between the second color layer and the adhesive layer is preferably greater than the adhesive force between the first color layer and the first functional layer. The adhesive force between the first and second color layers is preferably greater than the adhesive force between the first color layer and the first functional layer.

The ratio of the adhesive force between the second color layer and the adhesive layer to the adhesive force between the first color layer and the first functional layer is preferably greater than 1, and/or in particular lies in a range of from 1 to 2. The adhesive force between the second color layer and the adhesive layer is expediently greater, preferably much greater, than the adhesive force between the first color layer and the first functional layer, in particular with the result that the predetermined breaking point runs between the first color layer and the first functional layer.

The ratio of the adhesive force between the first color layer and the second color layer to the adhesive force between the first color layer and the first functional layer is preferably greater than 1, and/or in particular lies in a range of from 1 to 2. The adhesive force between the first color layer and the second color layer is expediently greater, preferably much greater, than the adhesive force between the first color layer and the first functional layer, in particular with the result that the predetermined breaking point runs between the first color layer and the first functional layer.

The ratio of the adhesive force between the varnish layer and the first functional layer to the adhesive force between the first functional layer and the first color layer is preferably greater than 1, and/or in particular lies in a range of from 1 to 2.

The ratio of the adhesive force between the first color layer and the second color layer to the adhesive force between the first color layer and the second functional layer is preferably greater than 1, and/or in particular lies in a range of from 1 to 2.

The adhesive layer is preferably designed such that an adhesive force between the adhesive layer and a substrate surface that is higher, in particular significantly higher, than the adhesive force between or within the layers of the carrier ply and the intermediate ply is achieved. The adhesive layer is in particular designed such that the adhesive force between the adhesive layer and a substrate surface to which the adhesive layer is preferably to be glued, in particular made of cardboard, paperboard, steel, glass, PE or PVC, is higher than 5 N/cm, preferably lies in a range of from 5 N/cm to 20 N/cm.

The object named at the beginning can in particular also be achieved by a product sealed with the sealing label. The above-named adhesive forces and ratios of adhesive forces are in particular exhibited by the sealed product which has the sealing label and a substrate surface of the product, in particular made of cardboard, paperboard, steel, glass, PE or PVC, to which the sealing label is glued with the adhesive layer.

By cardboard is preferably meant paper with a mass per unit area of 150 g/m² to 600 g/m². Furthermore, by paperboard is preferably meant paper with a mass per unit area from 225 g/m². Thus, it is possible that a material which lies in an overlap area on account of its mass per unit area can be assigned to several terms.

By adhesive force is meant here in particular a separating force, i.e. preferably the force required to separate the respective plies or layers from one another or within themselves. The determination of the separating force is preferably established as described below. First of all, for example, a sample is produced for the determination of the adhesive force within a first test layer or between a first and second test layer, which are in particular in each case selected from carrier ply, in particular paper layer and/or varnish layer, intermediate ply, in particular first functional layer, second functional layer, first color layer and/or second color layer, and/or adhesive layer. This sample thus comprises at least the first test layer and optionally the second test layer. If necessary, the sample can furthermore be provided with carrier ply and adhesive layer.

The sample is thus formed, for example, as a label strip with a width of from 10 mm to 25 mm, preferably with a width of 25 mm, and a length of at least 80 mm. The label strip is preferably glued, by means of a contact pressure roller with a mass of 4 kg, to a substrate, for example on cardboard, paperboard, steel, glass, PE or PVC, in particular with the result that, unless the force of adhesion of the adhesive layer to the substrate is to be established, the force of adhesion to the substrate exceeds the adhesive force of the test layers. Then, an adhesion time of at least 24 hours is guaranteed.

The separating force can then be established using a suitable material testing machine, for example using an adhesion/release testing machine, preferably of the AR-2000 type from Rycobel (Deerlijk, Belgium), using a load sensor, which is configured according to the separating forces to be expected, preferably for measuring separating forces in the cN range. The carrier ply is expediently joined to the load sensor and the adhesion/release testing machine. The carrier ply of the label strip is then peeled off at a peel angle of 180° and a peel speed of 300 m/min, with the result that the first test layer is detached from the second test layer. The peel angle is the angle between the peel direction and the surface of the label strip on the substrate. In particular, the peel direction points in the direction of the length of the label strip glued to the substrate.

Here, the separating force is preferably specified in cN/cm, thus preferably in force per strip width. The measurement can be carried out with several samples and the arithmetic mean calculated. The measurement is expediently carried out with at least three samples. The above-named ratios can be calculated using the values obtained, for example.

If the adhesive force between varnish layer and first color layer is to be established, the first test layer is the varnish layer of the carrier ply for example and the second test layer is the first color layer. If the adhesive force between first color layer and first functional layer is to be established, the first test layer is the first color layer for example and the second test layer is the first functional layer.

Furthermore, it is possible for the intermediate ply to be designed such that a predetermined breaking point is additionally present in the carrier ply.

It is also possible for the opening area to represent only a partial area of the sealing label and/or for the opening area to be delimited by the predetermined breaking point in the carrier ply, preferably to be delimited at least in partial areas by the predetermined breaking point in the carrier ply.

Such predetermined breaking points preferably have been or are provided in that the adhesive forces within and between carrier ply, intermediate ply and adhesive layer are set to be higher in an area in which in particular no predetermined breaking points are provided in the intermediate ply than in the opening area with the predetermined breaking points in the intermediate ply. The carrier ply together with the parts of the intermediate ply detached by the internal separation of the intermediate ply can thus be detached and preferably ripped at an area of transition to the area without predetermined breaking points in the intermediate ply. For example, it is possible to provide at least the first and second functional layers only in the opening area, thus the area with predetermined breaking points in the intermediate ply, but not to provide at least the first and second functional layers in particular in the area outside of the opening area. It is also conceivable not to provide the intermediate ply in the area without a predetermined breaking point in the intermediate ply or in particular to provide only the carrier ply and the adhesive layer. The areas are preferably defined when viewed perpendicular to a plane spanned by the sealing label.

The area without predetermined breaking points in the intermediate ply preferably has a width of at least 0.5 mm, in particular in a range of from 0.5 mm to 50 mm.

A paper tear can thus advantageously be induced during detachment of the carrier ply or during opening of the label and the proof of opening can be improved. The destruction of the carrier ply associated with the omission in areas of the predetermined breaking points in the carrier ply, in particular the functional layers, advantageously in combination with the visual effect produced by the functional layers, brings about a very strong proof of first opening. Moreover, the usually irregular torn edges of the paper make it much more difficult to reseal the sealing label.

The first functional layer preferably has a layer thickness in a range of from 1 μm to 5 μm. In particular, the first functional layer has been or is formed of a water-based dispersion paint.

The first color layer preferably has a layer thickness in a range of from 1 μm to 5 μm. The first color layer preferably has been or is formed of a UV-curable printing ink. The first color layer preferably comprises or consists of one or more of the following materials: colorants, additives, binders, UV initiators.

The second functional layer preferably has a layer thickness in a range of from 1 μm to 5 μm. The second functional layer preferably has been or is formed of a water-based dispersion paint.

The second color layer in particular has a layer thickness in a range of from 1 μm to 5 μm. The second color layer preferably has been or is formed of a UV-curable printing ink.

The second color layer preferably comprises or consists of one or more of the following materials: colorants, additives, binders, UV initiators.

Water-based dispersion paints are used for example for the first and second functional layers, whereas UV printing inks are preferably used for the varnish layer, the first color layer and the second color layer. The UV printing inks are or have been cured by means of UV light after the application of the respective layer.

Flexographic printing is preferably used for the application of the first and/or second functional layer, the first and/or second color layer and/or the varnish layer. Other printing methods, selected individually or in combination from gravure printing, screen printing, offset printing, pad printing, inkjet printing, can also be used for the application of the first and/or second functional layer, the first and/or second color layer and/or the varnish layer.

The layer thickness of the adhesive layer preferably lies in a range of from 10 μm to 50 μm. In particular, the adhesive layer has been or is deposited on the intermediate ply, in particular the second color layer, with an application weight in a range of from 10 g/m² to 50 g/m². In particular, the adhesive layer comprises, or the adhesive layer consists of, acrylate, natural rubber, synthetic rubber or combinations thereof.

For applying the adhesive layer, the adhesive layer has been or is laminated on, for example in the form of a so-called “Transfer Fix”. A “Transfer Fix” in particular describes a bonding agent which is placed between two transparent films, preferably also called liners. In the method for producing the sealing label, one of the two transparent films, in particular the two liners, is preferably peeled off and the bonding agent is laminated on the remaining transparent film, in particular the remaining liner, on the side of the intermediate ply facing away from the carrier ply, in particular laminated on the second color layer.

Acrylic bonding agents are preferably used for the adhesive layer. They advantageously have a very good resistance to external influences, such as for example UV irradiation, humidity or solvents, and the adhesive properties can be very easily set and controlled in the polymerization process. A sufficient adhesion can thus be achieved for a wide variety of packaging substrates, such as paper, glass, ceramic, plastic, metal, etc.

The adhesive layer is preferably designed such that the adhesive force of the agent used on the respective product substrate is in particular greater than 5 N/cm and thus is preferably much greater than the forces for separating the color and functional layers used from one another, which preferably lie in the cN/cm range.

It has additionally proved to be advantageous for at least one of the first functional layer and second functional layer to be UV-luminescent. When irradiated with UV light, a UV-luminescent layer preferably emits light visible to the human eye, in particular in a wavelength range of from 380 nm to 430 nm.

In particular, a register mark has been or is produced by means of UV-luminescent pigments. The UV luminescence can advantageously be used for detecting the position of the register mark. Then, it is possible to carry out a register-accurate application of one or more layers of the sealing label in relation to this register mark, in particular for the application of at least two layers in register with one another, selected from carrier ply, first functional layer, second functional layer, first color layer, second color layer, varnish layer, decorative ply and adhesive layer.

It has in particular proved to be advantageous for the first functional layer preferably to have been or be provided with UV-luminescent pigments. In particular, a register mark, which is preferably irradiated with UV light before the application of the second functional layer in step b3), has been or is produced preferably by means of the UV-luminescent pigments and the position of the register mark is determined with the aid of the emitted light and is then preferably used for the alignment of a further layer, in particular the second functional layer and/or the decorative ply, in register with the first color layer.

It has is also conceivable for the second functional layer preferably to have been or be provided with UV-luminescent pigments.

In particular, a register mark, which is irradiated with UV light, preferably has been or is produced by means of the UV-luminescent pigments and the position of the register mark is determined with the aid of the emitted light and is then preferably used for the alignment of the decorative ply in register.

The first and/or second functional layer preferably has a proportion of UV-luminescent pigments in a range between 0.5 and 10 percent by mass, preferably between 2.5 and 5 percent by mass, in the mass of the respective functional layer.

An improved register accuracy can thus be achieved through the UV luminescence.

In an improved embodiment, the carrier ply, in particular the paper layer and preferably also the optional varnish layer, has no UV-luminescent constituents, in particular no optical, UV-luminescent brighteners. The carrier ply preferably has, in particular over the whole surface, a transmittance of over 90% in the range of UV wavelengths, in particular in the wavelength range of from 280 nm to 380 nm. In particular, the register-accurate printing process of the functional layers is thus improved by avoiding an additional UV luminescence.

By registered or in register or registration-accurately or register-accurately or registration accuracy or register accuracy is meant a positional accuracy of two or more layers relative to one other. The register accuracy is preferably to vary within a predefined tolerance, the register tolerance, which is to be as small as possible. At the same time, the register accuracy of several plies and/or layers relative to one other is an important feature in order to increase the process reliability. The positionally accurate positioning can be effected in particular by means of sensorially, preferably optically, detectable registration marks or register marks. These registration marks or register marks can represent either special separate elements or areas or layers, or themselves be part of the elements or areas or layers to be positioned. A ply or layer applied in register thus preferably has a defined positional relationship with respect to at least one other ply or layer with a predetermined maximum positional tolerance, for which, in the production method, preferably at least one sensor detects a register mark of this other ply or layer, the position of the other layer is determined and an alignment of the ply or layer to be applied in register is carried out in dependence on the position of the other layer.

It is also conceivable that only one of the two functional layers has been or is provided. It is further possible for the predetermined breaking points alternatively or additionally to have been or be provided or supported with gaps, preferably in the respective layer material, for example with punched holes and/or with perforations.

The sealing label is in particular used for sealing a product, wherein it is preferably possible for the following step to be carried out before and/or after an application of the sealing label to the product to be sealed:

applying a decorative ply, which in particular forms a second outer surface of the sealing label, to the paper layer, in particular printing it on.

In particular, it is further possible, in the method for producing the sealing label, to prepare several sealing labels, preferably according to the described method, preferably on a carrier ply, preferably an in particular self-supporting paper layer, which optionally has been or is provided with the varnish layer. The several sealing labels can, for example, be produced at the same time by means of the above-named steps and be present on the same carrier ply. It is then possible, through mechanical separation, for example punching, cutting and/or lasers, to carry out a separation of the sealing labels. The separation can, for example, take place before the application of the decorative ply, and the application of the decorative ply can then be carried out only after intermediate storage or transport, for example to a packaging process and/or a sealing.

### BRIEF DESCRIPTION OF THE DRAWINGS

The invention will be explained below by way of example with reference to several embodiment examples with the aid of the accompanying drawings. There are shown in:

FIG. 1a sealing label in cross section,

FIG. 2a a sealing label in cross section,

FIG. 2b an opened sealing label in cross section,

FIG. 3a a sealing label in cross section,

FIG. 3b an opened sealing label in cross section,

FIG. 4a a sealing label in cross section,

FIG. 4b an opened sealing label in cross section,

FIG. 5 a method for producing a sealing label.

### DETAILED DESCRIPTION

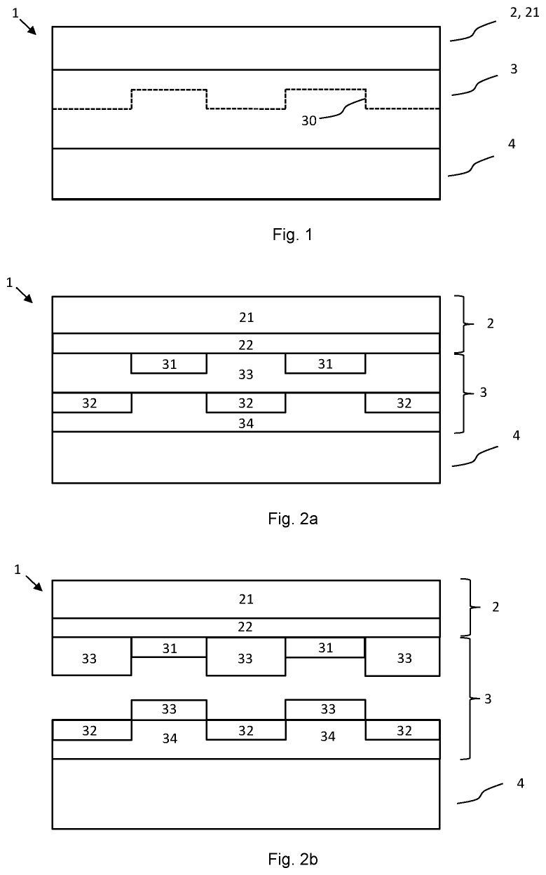

FIG. 1 schematically shows a cross section of an example of a sealing label 1. By a viewing perpendicular to a plane spanned by the sealing label 1 is preferably meant here a viewing in top view, thus, in particular in FIG. 1, perpendicularly from top to bottom.

The sealing label 1 has a carrier ply 2, an adhesive layer 4 and an intermediate ply 3.

The intermediate ply 3 is arranged between the carrier ply 2 and the adhesive layer 4. The intermediate ply 3 has predetermined breaking points 30 for the internal separation of the intermediate ply 3. The carrier ply 2 has at least the paper layer 21. The intermediate ply 3 is in particular designed such that it can be ripped or rips along the dashed separating line, which represents the predetermined breaking points 30, preferably when the sealing label 1 is glued to a sealed product and a force is introduced into the sealing label 1 via the carrier ply 2. As is shown by way of example in FIG. 1, the predetermined breaking points 30 can run along a direction between carrier ply 2 and adhesive layer 4 and also perpendicularly to this direction. Here, the z direction is thus in particular formed by a vertical direction.

The predetermined breaking points 30 can in particular be provided with a structure described in relation to FIGS. 2a, 2b, 3a, 3b, 4a and 4b. Alternatively or additionally, it is possible for the predetermined breaking points to have been or be provided or supported by means of gaps in the respective layer material, punched holes and/or perforations.

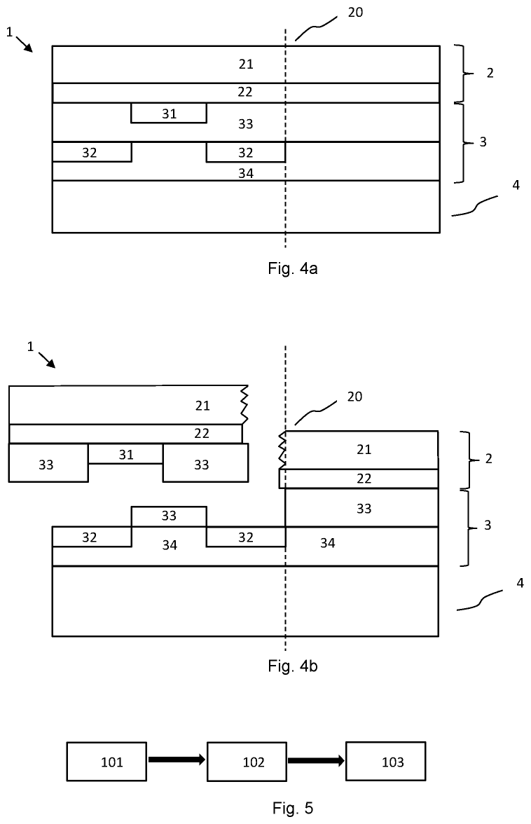

It is also conceivable that the sealing label 1 has an opening area, which is formed corresponding to the section represented by FIG. 1. Outside of the section, the sealing label 1 can also be without intermediate ply or at least without functional layers, for example, as can be seen by way of example in FIG. 4b, or also be formed without color layers. It is furthermore possible for the carrier ply 2 to have a tab, not represented here, for detaching the sealing label 1 from the sealed article.

The method for producing the sealing label 1 is described by way of example in relation to FIG. 5.

The paper layer 21 is preferably self-supporting. It is further possible that a plane spanned by the sealing label 1, here thus in particular in top view onto the sealing label 1, the paper layer 21 is completely comprised by the sealing label 1 and/or the sealing label 1 has the paper layer 21 over the whole surface. The paper layer 21 expediently fulfils the supporting function of the carrier ply 2. The paper layer 21 advantageously forms a first outer surface of the sealing label 1, which is represented in FIG. 1 for example by the uppermost side of the sealing label 1. The first outer surface can advantageously be coated, in particular can be printed on and/or is printed on at least in areas. The paper layer 21 in particular has a layer thickness in a range of from 0.05 mm to 0.1 mm. The paper layer 21 is, for example, arranged directly on the intermediate ply 3. However, it is also possible to provide the side of the paper layer 21 facing the intermediate ply 3 with a coating, in particular a varnish layer, as is described for example in relation to FIGS. 2 to 4. Advantageously, the paper layer 21 and the carrier ply 2 are semitransparent or transparent, in particular for wavelengths in a range of from 380 nm to 780 nm, preferably for wavelengths in the wavelength range visible to the human eye. A transparent paper is expediently used as paper layer 21. Transparent papers comprise, for example, silk papers, impregnated papers, plant-based papers and/or glassine. For example, the transparent paper, in particular from Canson, has a mass per unit area in the range of from 40 g/m² to 45 g/m², preferably a transmittance between 83% and 85%, preferably a haze value of 100% and in particular an image sharpness value of from 1.70% to 1.85%. For example, a transparent paper, in particular from Canson, is also possible which, with a mass per unit area of 70 g/m², has a transmittance of from 80% to 82%, a haze value of 100% and an image sharpness value of from 1.45% to 1.5%.

Through the paper layer 21 it is in particular achieved that an environmentally friendly carrier ply 2 with at the same time a good printability can be used, wherein it is possible to save on aftertreatments or further adhesion promoters and a first opening can be reliably proved.

FIG. 2a schematically shows an example of a sealing label 1 in a closed state, wherein this can for example also be a state glued to the product to be sealed. FIG. 2b schematically shows an example of a sealing label 1 in particular in an opened state. Here, the lower part with the adhesive layer 4 is for example glued to the product to be sealed or a substrate. In the opened state the opening feature, through which in particular the first opening can be proved, is preferably visible in top view. In the opened state the sealing label 1 is thus ripped corresponding to the predetermined breaking points 30, preferably in the opening area. The sealing label 1 of FIG. 2b has been gripped, for example, by a person using a tab (not represented) of the carrier layer 2 and peeled off. In the process, the sealing label 1 breaks open along the predetermined breaking line 30 according to FIG. 1, a peeled-off carrier ply 2, thus the part represented at the top in FIG. 2b, and a residue remaining on the sealed product, thus the part represented at the bottom in FIG. 2b, form.

FIG. 2a schematically shows in particular the sealing label 1 represented in FIG. 1, wherein the carrier ply 2 additionally has the varnish layer 22 and the intermediate ply 3 has the first functional layer 31, the second functional layer 32, the first color layer 33 and the second color layer 34. The intermediate ply 3 shown in FIG. 2a has the following layer structure, for example:
the functional layer 31 for setting an adhesive force in the intermediate ply 3, applied to the carrier ply 2, in particular to the varnish layer 22, not over the whole surface;
the first color layer 33 applied to the carrier ply 2, in particular the varnish layer 22, and the first functional layer 31,
the second functional layer 32 for setting an adhesive force in the intermediate ply 3, applied to the side of the first color layer 33 facing away from the carrier ply 2, not over the whole surface,
the second color layer 34, applied to the second functional layer 32 and first color layer 33 over the whole surface, wherein the second color layer 34 is arranged on the side of the intermediate ply 3 facing the adhesive layer 4.

Expediently, step b) of the production method comprises the following steps in the specified order:
b1) applying the first functional layer 31 for setting an adhesive force in the intermediate ply 3 to the carrier ply 2 not over the whole surface,
b2) applying a first color layer 33, in particular to the carrier ply 2 and first functional layer 31,
b3) applying a second functional layer 32 for setting an adhesive force in the intermediate ply 3 to the first color layer 33, preferably not over the whole surface,
b4) applying a second color layer 34, in particular to the second functional layer 31 and first color layer 33, preferably over the whole surface.

The first color layer 33 preferably has been or is applied to the carrier ply 2, in particular the varnish layer 22, over the whole surface or at least arranged in the intermediate ply 3 or in the opening area over the whole surface, if the intermediate ply 3 has been or is applied to the carrier ply 2 not over the whole surface. The first functional layer 31 in particular has been or is applied directly to the varnish layer 22, i.e. preferably without further layers between the first functional layer 21 and the varnish layer 22. The further layers can likewise be applied directly to one another, as is shown by way of example and schematically by FIG. 2a.

The first and second functional layers 31, 32 preferably have been or are formed complementary to one another. Complementary means that, in particular when viewed perpendicular to a plane spanned by the sealing label 1, here for example in a top view, the two functional layers 31, 32 cover the entire plane in the opening area and the functional layers 31 and 32 do not overlap. Here, the second functional layer 32 is formed corresponding to the first functional layer 31 and also printed on in the same way. In particular, the second functional layer 32 has been or is partially applied as a negative of the first functional layer 31, preferably applied to the first color layer 33.

Water-based dispersion paints have been or are used for example for the first and second functional layers 31, 32. UV-curing varnishes or UV-curing printing inks preferably have been or are used here for the varnish layer 22, the first color layer 33 and the second color layer 33. The UV-curing varnishes or printing inks preferably have been or are cured by means of UV light after the application of the respective layer. The second color layer 34 can have a color identical to or different from that of the first color layer 33. The first and second color layers 33 and 34 preferably have been or are formed in different colors and preferably chosen to be as high contrast as possible. For example, a blue color layer has been or is deposited as first color layer 33 and a white color layer has been or is deposited as second color layer 34. Here, by color is preferably meant the entire color spectrum of the Panton® or RAL® colors as well as black and white. Flexographic printing is used here, for example, for the application of the first and second functional layers 31, 32, the first and second color layers 33, 34 and the varnish layer 22.

The first functional layer 31 preferably has a layer thickness in a range of from 1 μm to 5 μm. The first color layer 33 preferably has a layer thickness in a range of from 1 μm to 5 μmm. The second functional layer 32 preferably has a layer thickness in a range of from 1 μm to 5 μm. The second color layer 34 in particular has a layer thickness in a range of from 1 μm to 5 μm. The layer thickness of the adhesive layer 4 preferably lies in a range of from 10 μm to 50 μm. In particular, the adhesive layer 4 has been or is deposited on the intermediate ply 3, in particular the second color layer 34, with an application weight in a range of from 10 g/m² to 50 g/m². The adhesive layer 4 of the sealing label 1 shown in FIG. 2a preferably has an adhesive layer with an application weight of 25 g/m².

In particular, the adhesive layer 4 comprises or the adhesive layer 4 consists of acrylate, natural rubber, synthetic rubber or combinations thereof. The adhesive layer preferably has been or is applied as a PSA (pressure sensitive adhesive) layer, which is preferably formed as an acrylic pressure sensitive adhesive. The sealing label 1 is in particular glued, or can be glued, to the product to be sealed by means of the adhesive layer 4.

For the application of the adhesive layer 4, the adhesive layer 4 is laminated on, for example in the form of a so-called “Transfer Fix”. A “Transfer Fix” in particular describes a bonding agent which is placed between two transparent films, preferably also called liners. In the method for producing the sealing label, one of the two transparent films, in particular the two liners, is preferably peeled off and the bonding agent is laminated on the remaining transparent film, in particular the remaining liner, on the side of the intermediate ply facing away from the carrier ply, in particular laminated on the second color layer.

Acrylic bonding agents are preferably used for the adhesive layer 4. They advantageously have a very good resistance to external influences, such as for example UV irradiation, humidity or solvents, and the adhesive properties can be very easily set and controlled in the polymerization process. A sufficient adhesion can thus be achieved for a wide variety of product substrates, in particular packaging substrates, such as paper, cardboard, paperboard, glass, ceramic, plastic, metal, etc. The adhesive layer is preferably designed such that the adhesive force of the agent used on the respective product substrate is greater than 5 N/cm and thus is preferably much greater than the forces for separating the color and functional layers used from one another, which preferably lie in the cN/cm range.

The adhesive layer 4 preferably has been or is arranged on the intermediate ply 3 over the whole surface, in particular when viewed perpendicular to a plane spanned by the sealing label 1. The adhesive layer 4 preferably has been or is applied to the second color layer 34 over the whole surface, in particular when viewed perpendicular to a plane spanned by the sealing label 1.

The functional layers represented in FIG. 2a are preferably formed as a release varnish layer. As is shown in FIG. 2b, the first color layer 33 can in particular thus be detached from the functional layers 31 and 32.

It is also conceivable that at least one layer or both layers out of the first functional layer 31 and second functional layer 32 are formed as primer, in particular in order to form the predetermined breaking points 30 on a side of the first color layer 31 which is facing away from the primer. Thus, the functional layers can be used in order to define the predetermined breaking points.

In particular, through the adhesive forces of the layers of the sealing label 1 described further above and their ratios to one another, it is possible to provide predetermined breaking points 30 in the intermediate ply 3, as are represented by way of example in FIG. 1. For this purpose, the first functional layer 31 preferably reduces the adhesive force between the first color layer 33 and the carrier ply 2, in particular compared with surrounding areas when viewed perpendicular to a plane spanned by the sealing label. The second functional layer 32 preferably reduces the adhesive force between first color layer 33 and adhesive layer 4, for example by reducing the adhesive force between first color layer 33 and second color layer 44, in particular compared with surrounding areas viewed perpendicular to a plane spanned by the sealing label.

Thus, it is possible, during the detachment of the carrier ply, for the first color layer 21 to be detached from the carrier ply 2 in an area determined by the first functional layer 21 and to remain on the adhesive layer 4, in particular to remain on the second color layer 34. It is further possible, during the detachment of the carrier ply 2, for the first color layer 33 to be detached from the adhesive layer 4 in an area determined by the second functional layer 32 and thus to be detached with the carrier ply 2, thus the first color layer 33 separates within itself and, outside of the areas determined by the first functional layer 31, is detached together with the carrier ply 2.

Expediently, the first and second functional layers 31, 32 have been or are arranged not overlapping at least in areas, in particular when viewed perpendicular to a plane spanned by the sealing label 1, thus here a top view. The first and second functional layers 31, 32 preferably have been or are formed complementary to one another. In particular when viewed perpendicular to a plane spanned by the sealing label, thus here a top view, the two functional layers 31, 32 therefore cover the entire surface in the opening area of the sealing label and do not overlap. In particular, the second functional layer 32 has been or is partially applied as a negative of the first functional layer 31, preferably applied to the first color layer 33.

For establishing the adhesive forces using the method described further above, in each case one or more layers of the sealing label 1 described in relation to FIG. 2b, on which the adhesive force of the corresponding sample is not to be measured, can be omitted for example.

It has additionally proved to be advantageous for at least one of the first functional layer 31 and second functional layer 32 to be UV-luminescent. In particular, a register mark has been or is produced in the respective layer by means of UV-luminescent pigments. The UV luminescence can advantageously be used for detecting the position of the register mark. It has in particular proved to be advantageous for the first functional layer 31 preferably to have been or be provided with UV-luminescent pigments. In particular, a register mark, which is preferably irradiated with UV light before the application of the second functional layer 32 in step b3), has been or is produced in the first functional layer 31 preferably by means of UV-luminescent pigments and the position of the register mark is determined with the aid of the emitted light and is then preferably used for the alignment of the second functional layer 32 in register with the first color layer 31.

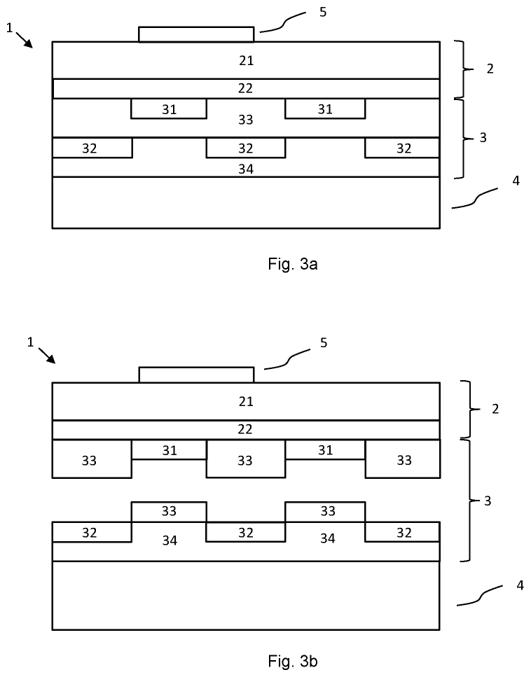

It is also conceivable that the second functional layer 32 has been or is provided with UV-luminescent pigments. In particular, a register mark, which is irradiated with UV light, has been or is produced preferably by means of the UV-luminescent pigments and the position of the register mark is determined with the aid of the emitted light and is then preferably used for the alignment of the decorative ply in register, as is described in more detail for example in relation to FIG. 3.

The first and/or second functional layer 31, 32 preferably has a proportion of UV-luminescent pigments in a range between 0.5 and 10 percent by mass, preferably between 2.5 and 5 percent by mass, in the mass of the respective functional layer.

An improved register accuracy can be achieved for example through the UV luminescence.

In an improved embodiment, the carrier ply 2, in particular the paper layer 21 and preferably also the optional varnish layer 22, has no UV-luminescent constituents, in particular no optical, UV-luminescent brighteners. The carrier ply 2 preferably has, in particular over the whole surface, a transmittance of over 90% in the range of UV wavelengths, in particular in the wavelength range of from 280 nm to 380 nm. In particular, the process for register-accurate printing of the functional layers 31, 32 or the decorative ply is thus improved by avoiding an additional UV luminescence.

As can furthermore be seen in particular in FIG. 2a and FIG. 2b, the varnish layer 22, which the carrier ply 2 has, is arranged on the side of the paper layer 21 facing the intermediate ply 3. The varnish layer 22 is preferably a leveling layer, which for example reduces the absorbency and/or unevenness and/or roughness of the paper layer 21, preferably on one side in cross section, on the side to which the intermediate ply 3 has been or is applied, and/or sets them to a substantially constant value in terms of area, in particular when viewed perpendicular to a plane spanned by the sealing label 1. The varnish layer 22 is advantageously also a stabilization layer, which for example increases the tear resistance of the carrier ply 2. The following step is expediently carried out between step a) and step b):

al) applying a varnish layer 22 to the paper layer 21.

It is also conceivable that step al) is carried out before step a) and the carrier ply 2 is provided together with paper layer 21 and varnish layer 22 in step a). The intermediate ply 3 is preferably applied to the varnish layer 22 in step b). The carrier ply 2 preferably consists exclusively of the varnish layer 22 and the paper layer 21.

Advantageously, through the varnish layer 22, the optical properties of the carrier ply 2 can be influenced in a targeted manner and thus, for example, an improved visibility of a first opening can be achieved and, through the varnish layer 22, in particular a constant separation behavior, preferably of the intermediate ply 3, can be achieved, for example also across different paper batches. Furthermore, a particularly reliable and simple adaptation of the varnish layer 22 and the intermediate ply 3 to one another can be achieved for producing the predetermined breaking points.

The layer thickness of the varnish layer 22 preferably lies in a range of from 1 μm to 10 μm, particularly preferably from 1 μm to 5 μm. The varnish layer 22 expediently has been or is applied to the paper layer 21 with an application weight in a range of from 2 g/cm² to 20 g/cm², in particular from 2 g/m² to 10 g/m². If a transparent paper and/or a paper layer with a mass of, for example, 50 g/m² has been or is used as paper layer, then the varnish layer 22 advantageously has a layer thickness in a range of from 3 μm to 7 μm.

The measurement of the layer thickness is preferably carried out on a cross section. If the layer thickness in the sealing label is influenced by an absorbent substrate, the layer thickness is in particular established on a non-absorbent substrate, as described above for example, and/or established, for example, immediately during the depositing of the corresponding ply or layer.

The varnish layer 22 preferably has been or is applied to the paper layer 21 over the whole surface. It is also possible for the intermediate ply 3 to be completely overlapped by the varnish layer 22 and/or for the varnish layer 22 to be present only in the opening area, in particular when viewed perpendicular to a plane spanned by the sealing label 1. It is further possible for the varnish layer 22 to extend beyond the intermediate ply 3.

In particular, the varnish layer 22 is semitransparent or transparent, in particular for wavelengths in a range of from 380 nm to 780 nm, preferably for wavelengths in the wavelength range visible to the human eye. In the example of FIG. 2, the varnish layer 22 preferably has a transmittance of over 90%, preferably for wavelengths in a range of from 380 nm to 780 nm, in particular for wavelengths in the wavelength range visible to the human eye. It is further possible for the varnish layer 22 to be colorless or to have no colorants, in particular for wavelengths in a range of from 380 nm to 780 nm, preferably at least in the wavelength range visible to the human eye.

The varnish layer 22 is preferably formed of a UV-curing varnish. A UV-curing varnish preferably is or has been cured by means of UV irradiation.

The UV-curing varnish preferably comprises the following three groups of UV-reactive materials: monomers or crosslinkers, binders or oligomers, and photoinitiators. Monomers or crosslinkers are used in particular for dissolving the binders, for setting the viscosity and the crosslinking of the UV system. Binders or oligomers are in particular mainly responsible for the properties in the cured state of the UV-curing varnish, such as for example scratch resistance, flexibility, elasticity and adhesion to substrates.

Photoinitiators in particular decompose photochemically or by means of electron beam radiation into radicals and thereby induce crosslinking reactions in the UV varnish.

The UV varnish of the varnish layer 22 preferably comprises binders, also referred to as resins or oligomers, which comprise crosslinkable groups selected from: olefinic groups, vinyl ether groups or epoxide groups, acrylate oligomers and acrylate monomers, methacrylates, acrylated polyesters, polyethers or polyurethanes.

The UV varnish preferably comprises monomers or crosslinkers selected individually or in combination from: butyl acrylate, (2-ethylhexyl) acrylate, as well as in particular multifunctional acrylates, such as 1,4-butanediol di(meth)acrylate, 1,6-hexanediol di(meth)acrylate or trimethylolpropane tri(meth)acrylate.

The UV varnish preferably comprises photoinitiators or photoinitiator systems, in particular radical photoinitiators, and in particular comprises selected individually or in combination from: ketone derivatives, diisopropyl xanthogen disulfide compounds, acetophenone compounds, benzophenones or benzoins.

The varnish layer 22, in particular the UV varnish, preferably has been or is applied to the paper layer with an application weight in a range of from 2 g/m² to 20 g/m², in particular from 2 g/cm² to 10 g/m². The varnish layer 22, in particular the UV varnish, preferably has been or is applied with a viscosity in a range of from 200 mPa*s to 500 mPa*s. It is hereby guaranteed, for example, that the varnish layer 22 levels out irregularities in the paper layer 21 because on the one hand it is not absorbed too much and on the other hand it runs sufficiently to form an even surface.

It is also conceivable that only one of the two functional layers has been or is provided. It is further possible for the predetermined breaking points alternatively or additionally to have been or be provided or supported with gaps in the respective layer material, for example punched holes or perforations.

FIG. 3a and FIG. 3b schematically show a cross section of an example of a sealing label 1, in particular the sealing label 1 described in relation to FIG. 2a and FIG. 2b, wherein the sealing label 1 is additionally provided with the decorative ply 5. The decorative ply 5 can advantageously have been or be applied directly to the paper layer 21. In particular in top view, the decorative ply 5 preferably forms a second outer surface of the sealing label.

The decorative ply 5 has been or is applied in particular partially, preferably in the shape of a motif. By “in the shape of a motif” is meant, for example, in one or more shapes out of geometric shape, guilloche, endless pattern, image, symbol, logo, coat of arms, portrait, alphanumeric characters, QR code, barcode. Herewith, for example logistical information, expiry dates or weblinks can also have been or be applied in the form of QR codes. It is thus possible for the paper layer 21 to form a first outer surface of the sealing label 1 and the decorative ply 5 to form a second outer surface of the sealing label 1, preferably when viewed in top view.

It is possible for the decorative ply 5 advantageously to comprise or consist of a printed layer. The decorative ply 5 is preferably applied by means of a method selected individually or in combination from flexographic printing, offset printing, gravure printing, pad printing, inkjet printing, xerography, cold stamping, hot stamping, thermal transfer. It is also conceivable that the decorative ply 5 comprises or consists of a metal layer. In addition, it is possible for the decorative ply 5 to comprise or consist of an optically variable element.

In particular, also in the closed state, the decorative ply 5 can give the sealing label 1 a visually appealing impression. Advantageously, the decorative ply 5 can also be applied at a very late manufacturing stage and with a very individual shaping, with the result that an improved individualizability of the sealing labels is achieved. In addition, the decorative ply 5 can form a very strong bond with the paper layer 21 due to the absorbency of the paper layer 21 on the first outer surface, with the result that, through the decorative ply 5, at the same time the stability can be improved and, for example, a wide range of printing inks and printing methods can be used.

The decorative ply 5 preferably has been or is applied in register, in particular in register with the intermediate ply 3, preferably with the first functional layer 31 and/or with the second functional layer 32. If the first functional layer 31 and/or the second functional layer 32 has a register mark, in particular a register mark formed by means of UV-luminescent pigments, this is preferably detected, and its position used for the register-accurate application of the decorative ply 5.

FIG. 4a and FIG. 4b schematically show a cross section of a sealing label 1, as is described for example in relation to FIG. 2a and FIG. 2b, which additionally has a predetermined breaking point 20. The sealing label 1 can also have the decorative ply 5 described in relation to FIG. 3a and FIG. 3b or be provided with it.

The intermediate ply 3 is in particular designed such that a predetermined breaking point 20 is additionally present in the carrier ply 2. The position of the predetermined breaking point 20 is indicated in FIG. 4a and FIG. 4b with the dashed line, which is depicted passing right through for better clarity, although the predetermined breaking point 20 is preferably not present in all layers, as can be seen from FIG. 4b. As can further be seen in particular from FIG. 4b, it is possible for the opening area to represent only a partial area of the sealing label 1 and/or for the opening area to be delimited by the predetermined breaking point 20 in the carrier ply 2.

Such predetermined breaking points 20 preferably have been or are provided in that, in an area in which in particular no predetermined breaking points 30 are provided in the intermediate ply 3, the adhesive forces within and between carrier ply 2, intermediate ply 3 and adhesive layer 4 are set to be higher than in an area with the predetermined breaking points 30 in the intermediate ply 3. The carrier ply 2 together with the parts of the intermediate ply 3 detached by the internal separation of the intermediate ply 3 can thus be detached and are preferably ripped at an area of transition to the area without predetermined breaking points 30 in the intermediate ply 3, in particular at an outer limit of the opening area. For example, it is possible to provide at least the first and second functional layers 31 and 32 only in the area with predetermined breaking points 30 in the intermediate ply 3, i.e.

thus not to provide at least the first and second functional layers 31 and 32 in particular in the area without predetermined breaking points 30 in the intermediate ply 3. It is also conceivable not to provide the intermediate ply 3 in the area without a predetermined breaking point in the intermediate ply 3 or in particular to provide only the carrier ply 2 and the adhesive layer 4. The areas are preferably defined when viewed perpendicular to a plane spanned by the sealing label 1, thus in a top view.

The area without predetermined breaking points 30 in the intermediate ply 3 has, for example, a width of at least 0.5 mm, in particular in a range of from 0.5 mm to 50 mm.

By means of the predetermined breaking point 20 in the carrier ply 2, a paper tear can advantageously be induced during the detachment of the carrier ply 2 or the opening of the label and the proof of opening can be improved, in particular compared with labels with thermoplastic films as carrier.

As can further be seen in FIG. 4, it is possible for the predetermined breaking points 20 present in the carrier ply 2 to extend at least partially into one or more of the following plies and layers: the varnish layer 22, the intermediate ply 3, the first color layer 33, the second color layer 34.

As FIG. 4 illustrates, it is also possible in particular for the opening area to represent only a partial area of the sealing label 1. In FIG. 4b, the opening area can be seen to the left of the dashed line by way of example. The opening area can thus be delimited for example by the predetermined breaking point 20 in the carrier ply.

FIG. 5 shows a method for producing a sealing label, as is described for example in relation to FIGS. 1 to 4. The method for producing comprises the steps, in particular in the specified order:
step a): providing 101 a carrier ply 2, wherein the carrier ply 2 has at least a paper layer 21,
step b): applying 102 an intermediate ply 3 to the carrier ply 2, wherein the intermediate ply 3 has predetermined breaking points 30 for the internal separation of the intermediate ply 3 or the predetermined breaking points 30 are produced in the intermediate ply 3,
step c): applying 103 an adhesive layer 4 to the intermediate ply 3.

It is also possible, for example, to use the paper layer 21 as carrier ply 2 for producing one or more sealing labels 1, as are described in relation to FIGS. 1 to 4.

It is in particular possible, in the method for producing the sealing label 1, to prepare several sealing labels 1 preferably on a self-supporting paper layer 21, for example as separate sheets or as a continuous web, which labels can then preferably be separated by mechanical separation, for example punching, cutting or by means of lasers. The separation can, for example, take place before the application of the decorative ply, and the application of the decorative ply can be carried out in particular after intermediate storage or transport, for example to a packaging process.

The sealing label 1 is used in particular for sealing a product. It is possible here for the following step to be carried out before and/or after an application of the sealing label 1 to the product to be sealed:
applying a decorative ply 5, which in particular forms a second outer surface of the sealing label 1, to the paper layer 21, in particular printing it on. As is described in relation to FIG. 3, a sealing label 1 produced in this way can in particular be designed wherein the adhesive layer 4 is glued to the product to be sealed.

A use of a carrier ply 2 comprising or consisting of a paper layer 21 for producing a sealing label 1 as shown in FIGS. 1 to 4 and for carrying out a method, as described in relation to FIG. 5, is advantageous in particular.

### List of Reference Numbers:

1 sealing label

2 carrier ply

21 paper layer

22 varnish layer

3 intermediate ply

20, 30 predetermined breaking points

31, 32 functional layers

33, 34 color layers

4 adhesive layer

5 decorative ply

What is claimed is:

1. A sealing label with a carrier ply, an adhesive layer, and an intermediate ply arranged between the carrier ply and the adhesive layer with predetermined breaking points for the internal separation of the intermediate ply, wherein the carrier ply has at least a paper layer.

2. The sealing label according to claim 1, wherein the carrier ply has a varnish layer, which is arranged on the side of the paper layer facing the intermediate ply.

3. The sealing label according to claim 1, wherein the intermediate ply is completely overlapped by the varnish layer, or the varnish layer extends beyond the intermediate ply.

4. The sealing label according to claim 1, wherein the varnish layer is semitransparent or transparent.

5. The sealing label according to claim 1, wherein the varnish layer is colorless and/or has no colorants.

6. The sealing label according to claim 1, wherein the varnish layer is formed of a UV-curing varnish.

7. The sealing label according to claim 1, wherein the varnish layer has a layer thickness in a range of from 1 μm to 10 μm, and/or is applied to the paper layer with an application weight in a range of from 2 g/m² to 20 g/m².

8. The sealing label according to claim 1, wherein the paper layer comprises or consists of a transparent paper.

9. The sealing label according to claim 1, wherein the paper layer forms a first outer surface of the sealing label.

10. The sealing label according to claim 1, wherein the paper layer has a layer thickness in a range of from 0.05 mm to 0.1 mm.

11. The sealing label according to claim 1, wherein the paper layer has a decorative ply.

12. The sealing label according to claim 11, wherein the decorative ply comprises or consists of a printed layer.

13. The sealing label according to claim 11, wherein the decorative ply comprises or consists of a metal layer.

14. The sealing label according to claim 11, wherein the decorative ply comprises or consists of an optically variable element.

15. The sealing label according to claim 11, wherein the decorative ply is applied in register.

16. The sealing label according to claim 1, wherein the intermediate ply has the following layers:
a first functional layer for setting an adhesive force in the intermediate ply, applied to the carrier ply not over the whole surface,
a first color layer applied to the carrier ply and first functional layer,
a second functional layer for setting an adhesive force in the intermediate ply, applied to the first color layer not over the whole surface,
a second color layer, applied to the second functional layer and first color layer over the whole surface.

17. The sealing label according to claim 16, wherein the first functional layer is designed such that the adhesive force between first functional layer and first color layer is smaller than the adhesive force between first color layer and a layer directly adjacent to it, and wherein the second functional layer is designed such that the adhesive force between second functional layer and first color layer is smaller than the adhesive force between second functional layer and a layer directly adjacent to it.

18. The sealing label according to claim 16, wherein the first functional layer is applied directly to the varnish layer.

19. The sealing label according to claim 16, wherein the adhesive layer is applied to the second color layer over the whole surface.

20. The sealing label according to claim 16, wherein the first and second functional layers are arranged not overlapping at least in areas.

21. The sealing label according to claim 16, wherein at least one of the first functional layer anond functional layer is UV-luminescent.

22. The sealing label according to claim 16, wherein the first functional layer has a layer thickness in a range of from 1 μm to 5 μm.

23. The sealing label according to claim 16, wherein the first functional layer is formed of a water-based dispersion paint.

24. The sealing label according to claim 16, wherein the first color layer has a layer thickness in a range of from 1 μm to 5 μm.

25. The sealing label according to claim 16, wherein the first color layer is formed of a UV-curable printing ink.

26. The sealing label according to claim 16, wherein the second functional layer has a layer thickness in a range of from 1 μm to 5 μm.

27. The sealing label according to claim 16, wherein the second functional layer is formed of a water-based dispersion paint.

28. The sealing label according to claim 16, wherein the second color layer has a layer thickness in a range of from 1 μm to 5 μm.

29. The sealing label according to claim 16, wherein the second color layer is formed of a UV-curable printing ink.

30. The sealing label according to claim 1, wherein the ratio of the adhesive force between the second color layer and the adhesive layer to the adhesive force between the first color layer and the first functional layer is greater than 1.

31. The sealing label according to claim 1, wherein the ratio of the adhesive force between the varnish layer and the first functional layer to the adhesive force between the first functional layer and the first color layer is greater than 1, and/or wherein the ratio of the adhesive force between the first color layer and the second color layer to the adhesive force between the first color layer and the first functional layer is greater than 1.

32. The sealing label according to claim 1, wherein the adhesive layer is designed such that the adhesive force between the adhesive layer and a substrate surface to which the adhesive layer is to be glued is higher than 5 N/cm.

33. The sealing label according to claim 1, wherein the ratio of the adhesive force between the varnish layer and the first color layer to the adhesive force between the first functional layer and the first color layer is greater than 1.

34. The sealing label according to claim 1, wherein the ratio of the adhesive force between the first color layer and the second color layer to the adhesive force between the first color layer and the second functional layer is greater than 1.

35. The sealing label according to claim 1, wherein the intermediate ply is designed such that predetermined breaking points are additionally present in the carrier ply.

36. The sealing label according to claim 35, wherein the predetermined breaking points present in the carrier ply adjoin the first and/or second functional layer at an opening area.

37. The sealing label according to claim 35, wherein the predetermined breaking points present in the carrier ply extend at least partially into one or more of the following plies and layers: the varnish layer, the intermediate ply.

38. The sealing label according to claim 1, wherein the adhesive layer has a layer thickness in a range of from 10 μm to 50 μm, and/or is deposited on the intermediate ply with an application weight in a range of from 10 g/m² to 50 g/m².

39. The sealing label according to claim 1, wherein the adhesive layer comprises or consists of one or more materials selected from acrylate, natural rubber, synthetic rubber.

40. A method for producing a sealing label, the method comprising:
a) providing a carrier ply, wherein the carrier ply has at least a paper layer,
b) applying an intermediate ply to the carrier ply, wherein the intermediate ply has predetermined breaking points for the internal separation of the intermediate ply, or the predetermined breaking points are produced in the intermediate ply, and
c) applying an adhesive layer to the intermediate ply.

41. The method according to claim 40, wherein the following step is carried out between step a) and step b):
a1) applying a varnish layer to the paper layer, and
wherein the intermediate ply is applied to the varnish layer in step b).

42. The method according to claim 41, wherein the varnish layer is applied in step a1) by means of flexographic printing.

43. The method according to claim 40, further comprising:
applying a decorative ply to the paper layer.

44. The method according to claim 40, wherein the decorative ply is applied in register.

45. The method according to claim 40, wherein step b) comprises the following steps:
b1) applying a first functional layer for setting an adhesive force in the intermediate ply, not over the whole surface;
b2) applying a first color layer to the carrier ply and first functional layer (31);
b3) applying a second functional layer for setting an adhesive force in the intermediate ply to the first color layer not over the whole surface; and
b4) applying a second color layer to the second functional layer and first color layer over the whole surface.

46. The method according to claim 40, wherein the first functional layer has been or is provided with UV-luminescent pigments and a register mark is produced, which is irradiated with UV light before the application of the second functional layer in step b3) and the position of the register mark is determined with the aid of the emitted light.
